(19) United States
(12) Patent Application Publication
(10) Pub. No.: US 2023/0082856 A1
(43) Pub. Date: Mar. 16, 2023

(54) Rear View Camera Assembly

(71) Applicant: Daniel Lutes, Venetia, PA (US)

(72) Inventor: Daniel Lutes, Venetia, PA (US)

(21) Appl. No.: 17/475,022

(22) Filed: Sep. 14, 2021

(51) Int. Cl. B60R 1/00; B60R 11/04; H04N 7/18; H04N 5/232

(52) U.S. Cl. CPC B60R 1/00; B60R 11/04; H04N 7/183; H04N 5/23299; B60R 2011/004

(57) ABSTRACT

A rear view camera assembly includes an actuator that is mounted to a bottom side of a vehicle. The actuator is actuatable into an extended condition or a retracted condition. A camera is coupled to the actuator and the camera has a pair of lenses. Each of the lenses is partially angled toward a respective right side and left side of the vehicle to capture imagery within 180.0 degrees of the rear end of the vehicle. A display is disposed in the vehicle such that the display is visible to the driver. The display displays video footage of the imagery captured by each of the lenses on the camera to facilitate a driver of the vehicle to see objects approaching from either the right side or the left side when the driver is backing the vehicle.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to camera devices and more particularly pertains to a new camera device for displaying an area behind a vehicle while the vehicle is backing. The device includes an actuator and which extends a camera beyond a rear end of the vehicle. The camera has a pair of lenses that are each angled in opposite directions from each other. The device includes a display mounted in the vehicle which displays footage captured by the camera. In this way a driver of the vehicle can see objects approaching from the left or the right while the driver is backing the vehicle.

### (2) Description of Related Art Including Information Disclosed Under 37 CFR 1.97 and 1.98

The prior art relates to camera devices including a vehicle camera device that includes a camera mounted to a body panel of a vehicle. The prior art discloses a vehicle camera device that includes a pair of cameras which have partially overlapping fields of view for facilitating a three dimensional image to be viewed within a vehicle. The prior art discloses a camera mirror device for redirecting the field of view of a tailgate camera on a pickup when the tailgate is lowered. The prior art discloses a rear view camera device that mounts to a hitch receiver of a vehicle and which includes a display that is mountable within the vehicle. The prior art discloses a camera that is removably mounted to a vehicle such that the camera can be mounted to the rear of a trailer being towed by the vehicle.

### BRIEF SUMMARY OF THE INVENTION

An embodiment of the disclosure meets the needs presented above by generally comprising an actuator that is mounted to a bottom side of a vehicle. The actuator is actuatable into an extended condition or a retracted condition. A camera is coupled to the actuator and the camera has a pair of lenses. Each of the lenses is partially angled toward a respective right side and left side of the vehicle to capture imagery within 180.0 degrees of the rear end of the vehicle. A display is disposed in the vehicle such that the display is visible to the driver. The display displays video footage of the imagery captured by each of the lenses on the camera to facilitate a driver of the vehicle to see objects approaching from either the right side or the left side when the driver is backing the vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a rear perspective view of a rear view camera assembly according to an embodiment of the disclosure.

FIG. 2 is a rear view of an embodiment of the disclosure.

FIG. 3 is a left side view of an embodiment of the disclosure.

FIG. 4 is a bottom view of an embodiment of the disclosure.

FIG. 5 is an interior view of an embodiment of the disclosure.

### DETAILED DESCRIPTION OF THE INVENTION

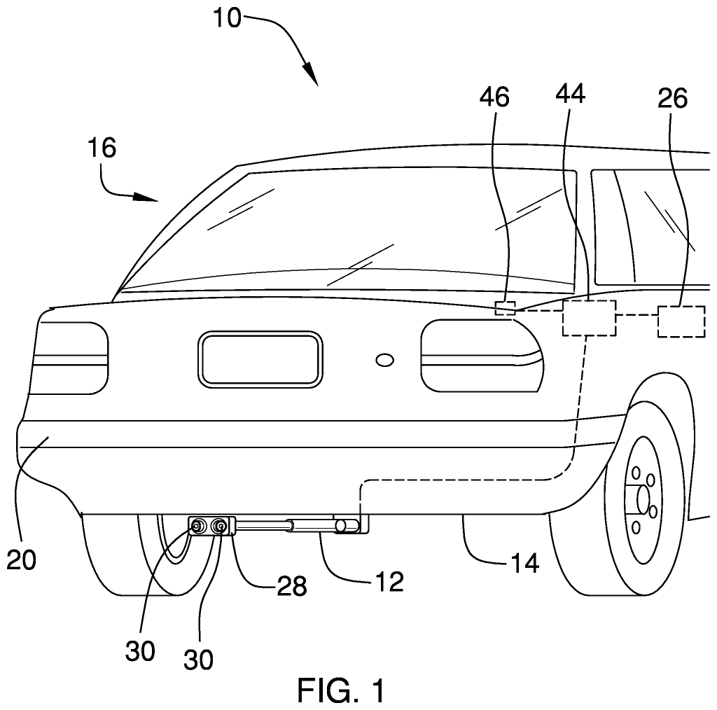

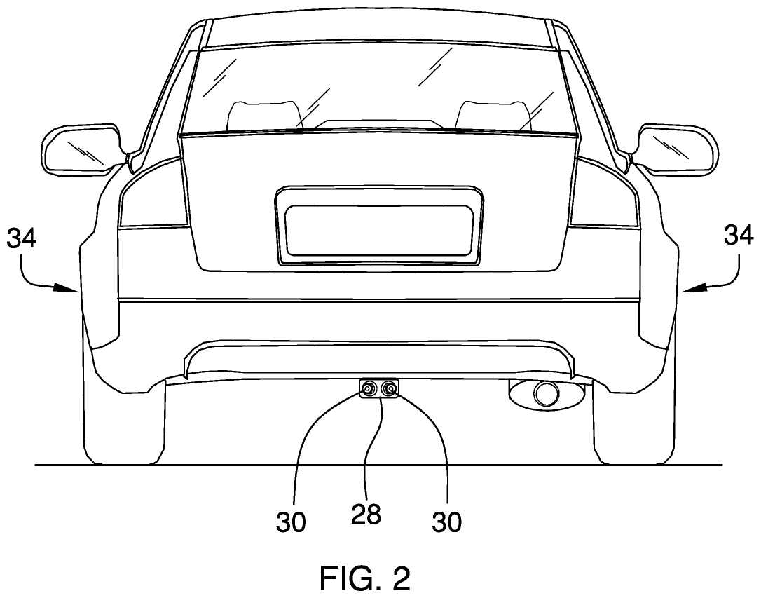

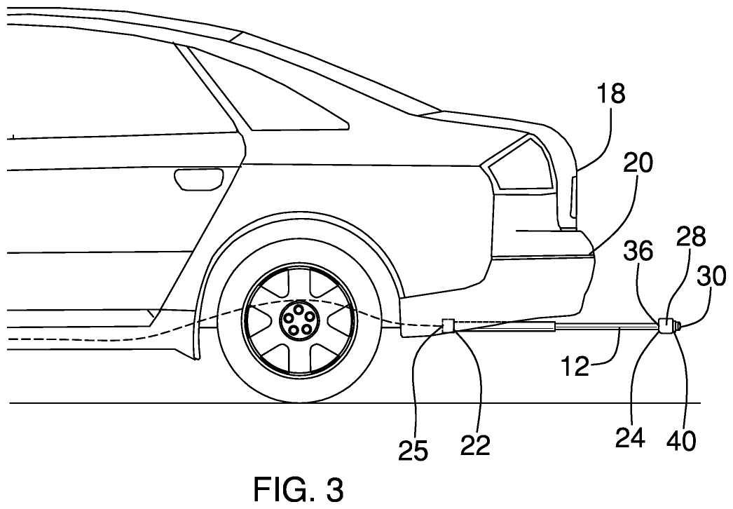

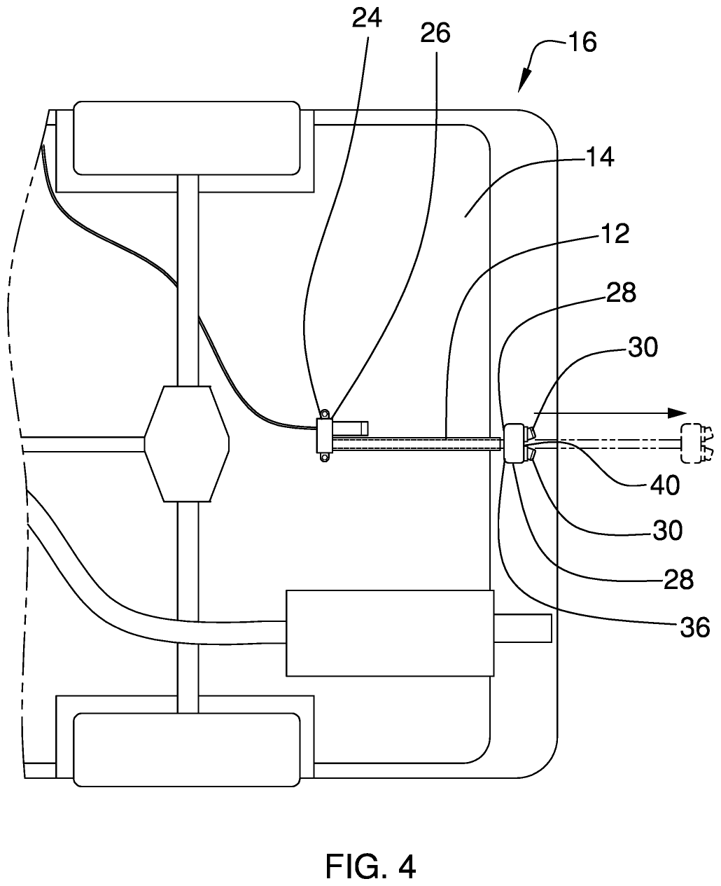

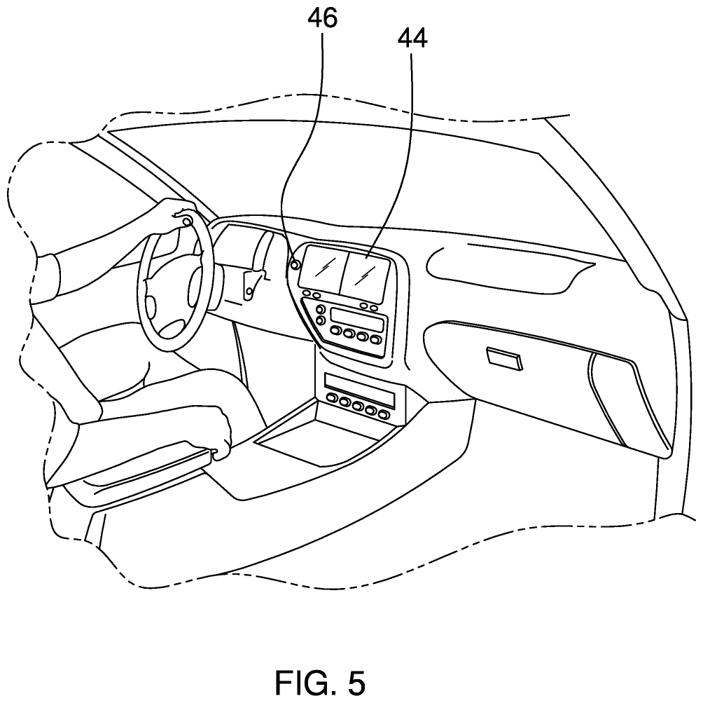

With reference now to the drawings, and in particular to FIGS. 1 through 5 thereof, a new camera device embodying the principles and concepts of an embodiment of the disclosure and generally designated by the reference numeral 10 will be described.

As best illustrated in FIGS. 1 through 5, the rear view camera assembly 10 generally comprises an actuator 12 that is mounted to a bottom side 14 of a vehicle 16. The vehicle 16 may be a passenger vehicle, a cargo vehicle or any other motorized vehicle. The actuator 12 is actuatable into an extended condition having the actuator 12 extending beyond a rear end 18 of the vehicle 16. Conversely, the actuator 12 is actuatable into a retracted condition having the actuator 12 being retracted beneath the vehicle 16. The actuator 12 might also extend through a rear bumper 20 of the vehicle 16 when the actuator 12 is actuated into the extended condition.

The actuator 12 has a first end 22 and a second end 24, and the first end 22 is mounted to a mounting point 25 on the bottom side 14 of the vehicle 16. The actuator 12 is extendable or retractable between the first end 22 and the second end 24. The second end 24 is spaced beyond the rear end 18 of the vehicle 16 when the actuator 12 is in the extended condition. Conversely, the second end 24 is positioned beneath the vehicle 16 when the actuator 12 is in the retracted condition. The actuator 12 is electrically coupled to an electrical system 26 of the vehicle 16. Furthermore, the actuator 12 may comprise a linear actuator 12 with a telescopic pole or other similar type of electro-mechanical device that can lengthen or shorten along a single axis.

A camera 28 is provided and the camera 28 is coupled to the actuator 12. The camera 28 has a pair of lenses 30 and each of the lenses 30 is partially angled toward a respective right side 32 and left side 34 of the vehicle 16. In this way the camera 28 can capture imagery within 180.0 degrees of the rear end 18 of the vehicle 16. The camera 28 has a rear side 36 and a front side 40, and the rear side 36 is coupled to the second end 24 of the actuator 12. Each of the lenses 30 is positioned on the front side 40 and each of the lenses 30 angles in opposite lateral directions from each other with respect to a center 42 of the front side 40. The camera 28 is spaced from the rear end 18 of the vehicle 16 when the actuator 12 is in the elongated condition. In this way the camera 28 can capture unobstructed imagery of the area behind and next to the vehicle 16.

A display 44 is disposed in the vehicle 16 such that the display 44 is visible to the driver. The display 44 is in communication with the camera 28 and the display 44 displays video footage of the imagery captured by each of the lenses 30 on the camera 28. In this way the display 44 can facilitate the driver of the vehicle 16 to see objects approaching from either the right side 32 or the left side 34 when the driver is backing the vehicle 16. The video footage may be arranged in a spit screen orientation on the display 44 and the display 44 may comprise a liquid crystal display or other type of electronic display that is integrated into a dashboard of the vehicle 16. The display 44 is electrically coupled to the electrical system 26 of the vehicle 16 and the display 44 is electrically coupled to the camera 28. The display 44 might comprise a personal electronic device, such as a smart phone for example, that can be paired with a wireless communication system in the vehicle 16. In this way the personal electronic device can display the video footage of the imagery captured by each of the lenses 30.

A control 46 is disposed in the vehicle 16 such that the control 46 is accessible to the driver. The control 46 is in communication with the actuator 12 and the control 46 actuates the actuator 12 between the extended condition and the retracted condition. The control 46 is electrically coupled to the actuator 12 and the control 46 may comprise a button that is mounted on the dashboard of the vehicle 16. The control 46 may comprise a circuit that is in communication with a gear selector of the vehicle 16 such that the actuator 12 is actuated into the extended condition when the gear selector is in a reverse gear or actuated into the retracted condition when the gear selector is in a forward gear.

In use, the actuator 12 is actuated into the extended condition when the vehicle 16 is backing such that the camera 28 is spaced from the rear end 18 of the vehicle 16. In this way the camera 28 can capture an unobstructed 180.0 degree view of the area behind the vehicle 16. Furthermore, the display 44 displays the video footage captured by the camera 28 such that the driver can view the video footage. In this way the driver can see objects, such as vehicles or pedestrians for example, that are approaching from either the left side 34 or the right side 32 of the vehicle 16. Thus, the driver can more safely back the vehicle 16 out of a parking spot, for example, or other situation that requires the driver to operate the vehicle 16 in a reverse gear.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A rear view camera assembly for displaying a multiple angle view of an area behind a vehicle, said assembly comprising:
an actuator being mounted to a bottom side of a vehicle, said actuator being actuatable into an extended condition having said actuator extending beyond a rear end of the vehicle, said actuator being actuatable into a retracted condition having said actuator being retracted beneath the vehicle;
a camera being coupled to said actuator, said camera having a pair of lenses, each of said lenses being partially angled toward a respective right side and left side of the vehicle wherein said camera is configured to capture imagery within 180.0 degrees of the rear end of the vehicle; and
a display being disposed in the vehicle wherein said display is configured to be visible to the driver, said display being in communication with said camera, said display displaying video footage of the imagery captured by each of said lenses on said camera wherein said display is configured to facilitate a driver of the vehicle to see objects approaching from either the right side or the left side when the driver is backing the vehicle.

2. The assembly according to claim 1, wherein said actuator has a first end and a second end, said first end being mounted to a mounting point on the bottom side of the vehicle, said actuator being extendable or retractable between said first end and said second end, said second end being spaced beyond the rear end of the vehicle when said actuator is in said extended condition, said second end being positioned beneath the vehicle when said actuator is in said retracted condition, said actuator being electrically coupled to an electrical system of the vehicle.

3. The assembly according to claim 2, wherein said camera has a rear side and a front side, said rear side being coupled to said second end of said actuator, each of said lenses being positioned on said front side, each of said lenses angling in opposite lateral directions from each other with respect to a center of said front side, said camera being spaced from the rear end of the vehicle when said actuator is in said elongated condition wherein said camera is configured to capture unobstructed imagery of the area behind and next to the vehicle.

4. The assembly according to claim 1, further comprising a control being disposed in the vehicle wherein said control is configured to be accessible to the driver, said control being in communication with said actuator, said control actuating said actuator between said extended condition and said retracted condition, said control being electrically coupled to said actuator.

5. A rear view camera assembly for displaying a multiple angle view of an area behind a vehicle, said assembly comprising:
an actuator being mounted to a bottom side of a vehicle, said actuator being actuatable into an extended condition having said actuator extending beyond a rear end of the vehicle, said actuator being actuatable into a retracted condition having said actuator being retracted beneath the vehicle, said actuator having a first end and a second end, said first end being mounted to a mounting point on the bottom side of the vehicle, said actuator being extendable or retractable between said first end and said second end, said second end being spaced beyond the rear end of the vehicle when said actuator is in said extended condition, said second end being positioned beneath the vehicle when said actuator is in said retracted condition, said actuator being electrically coupled to an electrical system of the vehicle;
a camera being coupled to said actuator, said camera having a pair of lenses, each of said lenses being partially angled toward a respective right side and left side of the vehicle wherein said camera is configured to capture imagery within 180.0 degrees of the rear end of the vehicle, said camera having a rear side and a front side, said rear side being coupled to said second end of said actuator, each of said lenses being positioned on said front side, each of said lenses angling in opposite lateral directions from each other with respect to a center of said front side, said camera being spaced from the rear end of the vehicle when said actuator is in said elongated condition wherein said camera is configured to capture unobstructed imagery of the area behind and next to the vehicle;
a display being disposed in the vehicle wherein said display is configured to be visible to the driver, said display being in communication with said camera, said display displaying video footage of the imagery captured by each of said lenses on said camera wherein said display is configured to facilitate a driver of the vehicle to see objects approaching from either the right side or the left side when the driver is backing the vehicle, said display being electrically coupled to the electrical system of the vehicle, said display being electrically coupled to said camera; and
a control being disposed in the vehicle wherein said control is configured to be accessible to the driver, said control being in communication with said actuator, said control actuating said actuator between said extended condition and said retracted condition, said control being electrically coupled to said actuator.

6. A rear view camera system for displaying a multiple angle view of an area behind a vehicle, said system comprising:
a vehicle having a bottom side and a rear end;
an actuator being mounted to said bottom side of said vehicle, said actuator being actuatable into an extended condition having said actuator extending beyond said rear end of said vehicle, said actuator being actuatable into a retracted condition having said actuator being retracted beneath said vehicle, said actuator having a first end and a second end, said first end being mounted to a mounting point on said bottom side of said vehicle, said actuator being extendable or retractable between said first end and said second end, said second end being spaced beyond said rear end of said vehicle when said actuator is in said extended condition, said second end being positioned beneath said vehicle when said actuator is in said retracted condition, said actuator being electrically coupled to an electrical system of said vehicle;
a camera being coupled to said actuator, said camera having a pair of lenses, each of said lenses being partially angled toward a respective right side and left side of said vehicle wherein said camera is configured to capture imagery within 180.0 degrees of said rear end of said vehicle, said camera having a rear side and a front side, said rear side being coupled to said second end of said actuator, each of said lenses being positioned on said front side, each of said lenses angling in opposite lateral directions from each other with respect to a center of said front side, said camera being spaced from said rear end of said vehicle when said actuator is in said elongated condition wherein said camera is configured to capture unobstructed imagery of the area behind and next to said vehicle;
a display being disposed in said vehicle wherein said display is configured to be visible to the driver, said display being in communication with said camera, said display displaying video footage of the imagery captured by each of said lenses on said camera wherein said display is configured to facilitate a driver of said vehicle to see objects approaching from either the right side or the left side when the driver is backing said vehicle, said display being electrically coupled to the electrical system of said vehicle, said display being electrically coupled to said camera; and
a control being disposed in said vehicle wherein said control is configured to be accessible to the driver, said control being in communication with said actuator, said control actuating said actuator between said extended condition and said retracted condition, said control being electrically coupled to said actuator.
